(19) United States
(12) Patent Application Publication
(10) Pub. No.: US 2026/0329434 A1
(43) Pub. Date: Oct. 22, 2026

(54) METHOD FOR COMPUTATIONAL REPRESENTATION OF DATA TO REDUCE SIZE AND INCREASE EFFICIENCY OF DATA TRANSMISSION AND STORAGE

(71) Applicant: Blu-Prnt Inc., Santa Cruz, CA (US)

(72) Inventor: Francisco Martinez, San Diego, CA (US)

(21) Appl. No.: 19/181,266

(22) Filed: Apr. 16, 2025

(51) Int. Cl. G06F 3/06

(52) U.S. Cl. CPC G06F 3/0608; G06F 3/0638; G06F 3/0655; G06F 3/0673

(57) ABSTRACT

A method of encoding and decoding data from one system to another, having steps including the creation of Blu-Prnt Package within the sending system utilizing the original data and a deconstructing algorithm, handling of the Blu-Prnt Package, and the recreation of the encoded data utilizing the transmitted Blu-Prnt Package and a reconstructing algorithm. Currently there is a problem in the industry in which existing infrastructure regarding worldwide bandwidth and storage capacity are strained with the amount of data to be handled on a daily basis, and expansion of that bandwidth and capacity will be expensive, both financially and environmentally. This method vastly increases the ability to use the existing infrastructure by making the transmission of data far more efficient, through reducing the file size of the transferred data. By reducing the footprint of the transmitted data beyond current capabilities, the world will be able to utilize existing bandwidth for handling more data, allowing costs to be saved both financially and environmentally. Another embodiment and use for the invention is to increase the efficiency of computer storage systems. The invention allows for the storage of more files on a single system by reducing the file size of the stored file beyond current capabilities, allowing the storage of more files and data within a given storage system.

### BACKGROUND OF THE INVENTION

### 1. Field of the Invention

Embodiments of the invention relate generally to the deconstruction and reconstruction of data in order to facilitate more efficient transmission and storage, more particularly, the use of an algorithm to derive instructions describing any generic data set rather than the original data in order to reduce the size of data prior to transmission or storage and allow the data to be rebuilt in its original form by a system that processes the instructions post-transmission or retrieval.

### 2. Description of Related Art

In modern society, data transmission and storage are essential for most daily activities, including sending emails, making phone calls, creating or consuming digital content, accessing information on the internet, conducting business through video conferencing, online shopping, and even operating smart home devices, essentially underpinning most digital interactions and communication across various platforms and devices. The ability to transmit and store large amounts of data quickly and efficiently is now required in both personal and professional settings. Data is transmitted over a point-to-point or point-to-multipoint communication channels, such as copper wires, optical fibers, wireless communications channels, volatile or long-term storage, and computer buses. First, the sending system generates the data to be transmitted or stored, converting it into a digital signal. Next, the data is encoded into a format suitable for the transmission or storage. The encoded data is sent through the chosen medium as electrical signals or light pulses, or stored accordingly. Finally, the receiving system receives the signal or retrieves the data from storage and decodes it back into its original data format.

A current issue in the digital communication industry is the limitations faced when attempting to transmit or store large amounts of data. The data transfer rate (DTR) is the speed at which a specified amount of data travels from one place to another. DTR=D/T. D is the total amount of digital data transferred and T is the total time it takes to transfer it. There are many factors that affect the DTR, and it is directly dependent upon the size and amount of data that is being transmitted, as well as the number of nodes data must travel through and the distance it must travel. Modern business needs and personal networking require the handling of voluminous amounts of data. DTR is an integral part of downloading applications, attending Zoom meetings, streaming movies, and playing videogames. Factors that affect DTR include: network bandwidth, network congestion, distance between devices, hardware capabilities, signal interference, file size, the type of network connection (wired vs. wireless), and the protocols used for data transmission. Essentially, the quality of the network connection and the capacity to handle data flow significantly impact the speed of data transfer. But one of the single most important factors is the size of the data being transferred. Similarly, storage technologies face scalability challenges in terms of augmenting density of data storage per unit of volume/area, as well as increasing the DTR from data storing devices.

This issue is further compounded when one takes into account the physical limitations and costs of transmitting and storing large amounts of data. As the amount of data handled all over the world every second increases, the infrastructure associated with it must also be expanded to accommodate the increase. This expansion comes with considerable cost, both in terms of economic costs of developing, manufacturing, placing, and maintaining such infrastructure, along with the significant environmental cost associated. A better solution would be to improve the transmission and storage process to utilize the existing infrastructure more efficiently, while enabling further developments by addressing scaling, complexity, thermal/power, and cost limiters.

In the past, compression algorithms have been utilized to achieve more efficient data handling, but such algorithms have a technical limitation. Compression algorithms alter the original data, reducing its size in either lossless or lossy fashion. Both have limitations. Lossless algorithms may be limited by the type of data that they may be applicable to, or they may not be able to achieve the desired reduction in transmission size. Lossy algorithms, by their nature, irreparably alter the data, as significant portions of the data are removed in order to reduce file size. This presents obvious issues and may result in degraded quality of data after the transmission. Similarly, the performance of compression algorithms tends to be very dependent on the type and characteristics of the data being compressed.

The inventive concept addresses these concerns by adding an algorithm at the commencement and conclusion of the transmission or storing of data which allows for the reconstruction of the data and reduces the size of the files being handled. This algorithm creates and sends instructions to rebuild the data, thereby reducing the transmitted file size and enabling the receiver to reconstruct the original data that the sender transmits without compromising the DTR or storage size because the original file is never transmitted. This invention is distinct from the existing approaches in the art in that its performance is not dependent on the type of data being handled. This algorithm further increases the efficiency and decreases the volume of the data being transmitted or stored. Further, this algorithm will also allow for increased use of existing infrastructure, reducing economic and environmental costs associated with the expansion of infrastructure utilizing the current paradigm, as well as help addressing future scaling limiters for data transmission and storage.

### SUMMARY OF THE INVENTION

The disclosed method allows for the effective handling (transmission and storage) of more data across existing infrastructure by reducing the footprint of the information being handled between the sender/producer and receiver/consumer of the data. This is achieved by the creation of the Blu-Prnt Package from the original data to be handled via an algorithm on the sending system, which acts as the producer of the Blu-Prnt Package. This package, which is much smaller than the original data, is then transmitted from the sending system to the receiving system via some local or remote transmission or storage method. The transmitted/retrieved package is then utilized by the receiving system, along with a reconstructing algorithm, to recreate a copy of the original data, which is then ready for general use by consumers of that data. In this way, the data that is actually handled between the systems, in terms of Blu-Prnt packages, is far smaller than the original raw data on each system, increasing efficiency in volume and throughput in handling the data. An additional use for this method is to make storage on a computer system far more efficient through the pre-processing of data to be stored. The method is similar, with the Blu-Prnt Package being generated and processed in a similar fashion, but the Blu-Prnt Package is not transmitted between machines, but rather stored and retrieved from storage within one machine.

### BRIEF DESCRIPTION OF THE DRAWINGS

FIG. 1 is a diagram of the first half of a particular embodiment of the invention, comprising the actions in generating the Blu-Prnt Package and transmitting it from the sending source.

FIG. 2 is a diagram of the second half of a particular embodiment of the invention, comprising the actions in transmitting the Blu-Prnt Package to the receiver and reconstructing the usable data.

FIG. 3 is a diagram of the first half of a particular embodiment of the invention, comprising the actions in generating the Blu-Prnt Package and placing it in temporary or long-term storage.

FIG. 4 is a diagram of the second half of a particular embodiment of the invention, comprising the actions in retrieving the Blu-Prnt Package from storage and reconstructing the usable data.

### DETAILED DESCRIPTION OF EMBODIMENTS

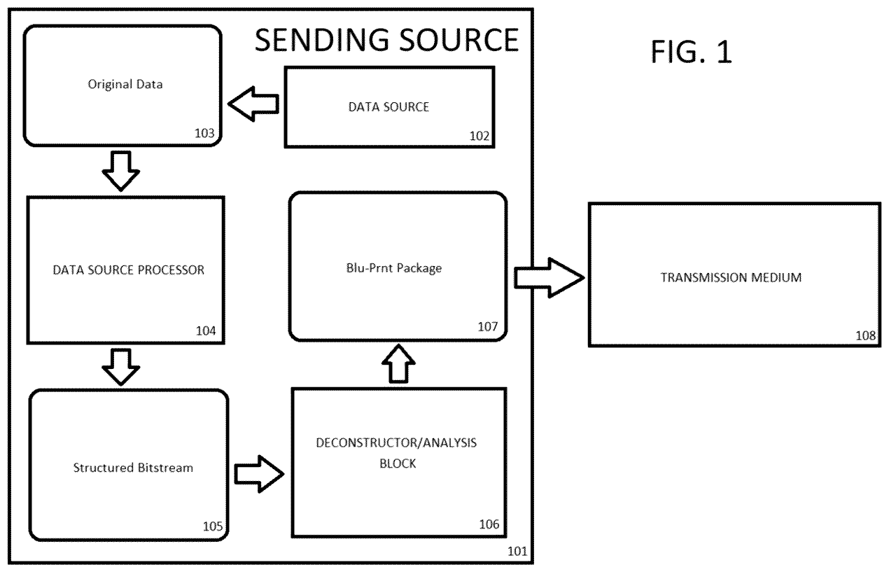

While the invention is illustrated and described in a preferred embodiment, the invention may be produced and described in many different configurations, forms, and various methods, without deviating from the scope of the present invention. The preferred embodiments of the invention are described in detail below with reference to the accompanying FIGS. 1-4, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the invention described herein.

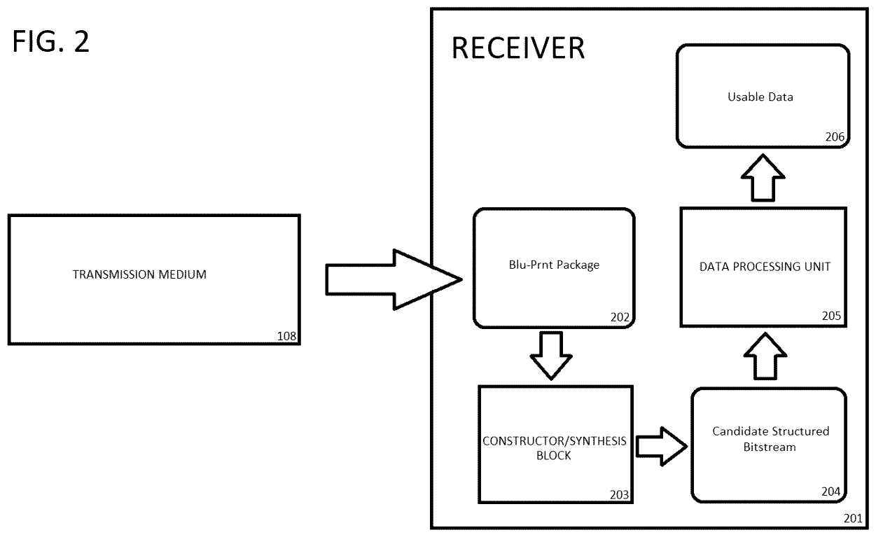

Referring now to FIGS. 1 and 2, a method is disclosed. The method is initiated when original data 103 from a data source 102 needs to be sent from a sending source 101 to a receiver 201. The data source 102 comes in various forms, including, but not limited to sensors, storage mediums, data bases, user input, or other sources of data. The original data 103 is most commonly, but not always, in the form of computer files or a data stream. The original data 103 is transformed by the data source processor 104 to generate a structured bitstream 105. The data source processor 104 also generates a set of key metrics and parameters for subsets of the structured bitstream 105. The data source processor 104 may work both synchronously or asynchronously. The data source processor 104 may be implemented in software, hardware, or both.

Once the data source processor 104 creates the structured bitstream where each bit member whitin it is assigned a unique identifier 105 and a set of associated parameters, the deconstructor/analysis block 106 utilizes one or several structured bitstreams 105 and their sets of associated parameters as inputs to create a Blu-Prnt Package 107. This is done by adding each member of the input structured bitstreams into the membership components within the Blu-Prnt Package using a set of encoding finite state machines and logic. The deconstructor/analysis block also supports the functionality to add or remove individual elements from the membership components of an existing Blu-Prnt Package as well. The Blu-Prnt Package 107 is created or modified to meet certain parameters, including, but not limited to, the time to create the Blu-Prnt Package 107, the size of the Blu-Prnt Package 107, or some other factor that causes the deconstructor/analysis block 106 to be interrupted. In all embodiments, the Blu-Prnt Package 107 has a smaller file size than the original data except for the corner case in which the original data set to be deconstructed/analyzed is smaller than the minimum size for a functional Blu-Prnt Package 103. In all embodiments, the Blu-Prnt Package 107 contains components that can be used to reconstruct the original data 103 with the proper algorithm. In some embodiments, the Blu-Prnt Package 107 may contain additional components, including, but not limited to, usage support facilities, such as identification factors, entitlement level information such as execution and read/write privileges, time to live and access counts, content protection and security support, and encryption support. In some embodiments, the Blu-Prnt Package 107 may contain integrity support facility, including, but not limited to, methods for error correction and tampering protection such as a signature and checksum set. The deconstructor/analysis block 106 may work both synchronously or asynchronously. The deconstructor/analysis block 106 may be implemented in software, hardware, or both.

Once the Blu-Prnt Package 107 is generated, it may be transmitted to the receiver 201 via some transmission method 108. The receiver 201 is some computing medium with the capability of performing computations to transform the Blu-Prnt Package 107 into usable data 206, as detailed further below. The transmission method 108 may take many forms, including, but not limited to, wired transmission, wireless transmission, transmission via a physical storage medium such as a USB drive or an external hard drive, or transmission within the local components of a computing system either hardware or software. The transmission method 108 is used to transmit the Blu-Prnt Package (107 in FIGS. 1, 202 in FIG. 2) to the receiver 201.

The Blu-Prnt Package 202 is utilized by the constructor/synthesis block 203 to create a candidate structured bitstream 204 from the Blu-Prnt Package created by the producer/sender system which contains the membership components data from the original structured bitstream 105 and the parameters drawn from it. The candidate structured bitstream is populated systematically by the constructor/synthesis block using a set of finite state machines and logic to query for presence in the membership component of the Blu-Prnt Package for each unique identifier for the set of members of the candidate structured bitstream, as well as sets of associated parameters. The constructor/synthesis block 203 may work both synchronously or asynchronously. The constructor/synthesis block 203 may be implemented in software, hardware, or both. Once the candidate structured bitstream is fully populated, it 204 is then processed by the data processing unit 205 to create raw usable data 206, which can be utilized by the receiver/consumer 201. The data processing unit 205 may work both synchronously or asynchronously. The data processing unit 205 may be implemented in software, hardware, or both.

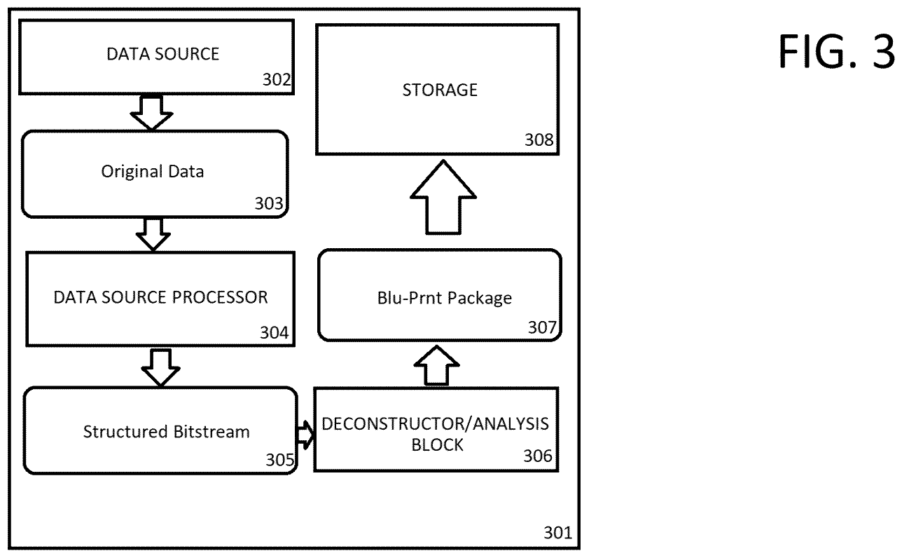

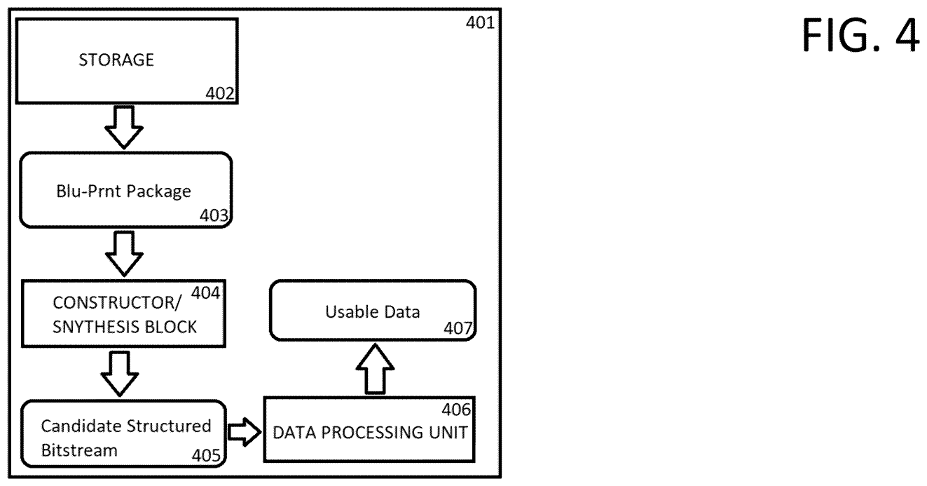

Referring to FIGS. 3 and 4, another embodiment is disclosed. In some embodiments, the method may be utilized for volatile or long-term storage of data in a system 301. The method is initiated when the original data 303 from a data source 302 is set to be stored in memory in the system 301. A structured bitstream 305 is generated from the original data 303 by a data source processor 304. This structured bitstream 305 is then utilized by a deconstructor/analysis block 306 to generate a Blu-Prnt Package 307. This Blu-Prnt Package 307, which has a much smaller file size than the original data 303, is then then stored in a volatile or long-term storage medium 308.

The embodiment may also be utilized to retrieve data from storage 402 for use by the system 401. This system 401 begins the method by obtaining the Blu-Prnt Package 403 from a volatile or long-term storage medium 402. The Blu-Prnt Package 403 is then utilized by a constructor/synthesis block 404 to generate a candidate structured bitstream 405. This candidate structured bitstream 405 is then utilized by a data processing unit 406 to generate usable data 407, which can the be utilized by the system 401.

In some embodiments, security measures such as encryption, authentication, and access control may be implemented to protect the data from unauthorized access and breaches.

The principles, embodiments, and modes of operation of the present invention have been set forth in the foregoing specification. The embodiments disclosed herein should be interpreted as illustrating the present invention and not as restricting it. The foregoing disclosure is not intended to limit the range of equivalent structures available to a person of ordinary skill in the art in any way, but rather to expand the range of equivalent structures in ways not previously contemplated. Numerous variations and changes can be made to the foregoing illustrative embodiments without departing from the scope and spirit of the present invention.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent particular aspects and embodiments of the invention and are therefore representative examples of the subject matter that is broadly contemplated by the present invention. It is further understood that the scope of the present invention fully encompasses other embodiments that are, or may become, obvious to those skilled in the art and that the scope of the present invention is accordingly not limited by the descriptions presented herein.

I claim:

1. A computer-implemented method for the encoding and/or replication of data, comprising
the steps of:
generating a structured bitstream and associated metrics from original raw data from a data source utilizing a data source processor;
generating a Blu-Prnt Package utilizing the generated structured bitstream utilizing a deconstructor/analysis block.

2. A computer-implemented method for the encoding and/or replication of data from a
sending system to a receiving system, comprising the steps of:
generating a structured bitstream and associated metrics from original raw data from a data source utilizing a data source processor;
generating a Blu-Prnt Package utilizing the generated structured bitstream utilizing a deconstructor/analysis block;
transmitting the generated Blu-Prnt Package from the sending source to the receiver utilizing a transmission method;
generating a candidate structured bitstream from the received Blu-Prnt Package utilizing a constructor/synthesis block;
generating a raw usable data from the candidate structured bitstream utilizing a data processing unit.

3. The method of claim 2, wherein the transmission method is a wireless transmission method.

4. The method of claim 2, wherein the transmission method is a wired transmission method.

5. The method of claim 2, wherein the transmission method is the utilization of portable storage devices.

6. A non-transitory computer-readable medium with instructions stored thereon, that when
executed by a processor, perform the steps comprising:
generating a structured bitstream from original data from a data source utilizing a data source processor;
generating a Blu-Prnt Package utilizing the generated structured bitstream utilizing a deconstructor/analysis block;
transmitting the generated Blu-Prnt Package from the sending source to the receiver utilizing a transmission method;
generating a candidate structured bitstream from the transmitted Blu-Prnt Package utilizing a constructor/synthesis block;
generating a raw usable data from the candidate structured bitstream utilizing a data processing unit.

7. The non-transitory computer-readable medium of claim 6, wherein the transmission method is a wireless transmission method.

8. The non-transitory computer-readable medium of claim 6, wherein the transmission method is a wired transmission method.

9. The non-transitory computer-readable medium of claim 6, wherein the transmission method is the utilization of portable storage devices.

10. A computer-implemented method for the encoding and/or replication of data for storage in
a computer system, comprising the steps of:
generating a structured bitstream and associated metrics from original raw data from a data source utilizing a data source processor;
generating a Blu-Prnt Package utilizing the generated structured bitstream and associated metrics utilizing a deconstructor/analysis block;
storing the generated Blu-Prnt Package in a volatile or long-term storage medium.

11. A computer-implemented method for retrieval of data from storage for use in a computer
system, comprising the steps of:
retrieving a Blu-Prnt Package from a volatile or long-term storage medium;
generating a candidate structured bitstream from the retrieved Blu-Prnt Package utilizing a constructor/synthesis block;
generating a raw usable data from the candidate structured bitstream utilizing a data processing unit.
